(19) United States
(12) Patent Application Publication
(10) Pub. No.: US 2022/0386604 A1
(43) Pub. Date: Dec. 8, 2022

(54) METHOD OF AND COMPOSITION FOR PROTECTING PLANTS AGAINST CERCOSPORA LEAF SPOT

(71) Applicant: Suntton Company Limited, Wan Chai (CN)

(72) Inventors: Liping Peng, Sacramento, CA (US); Xi Wang, Chilliwack (CA)

(21) Appl. No.: 17/692,025

(22) Filed: Mar. 10, 2022

Related U.S. Application Data
(60) Provisional application No. 63/193,954, filed on May 27, 2021.

(51) Int. Cl. A01N 43/22; A01P 3/00

(52) U.S. Cl. CPC A01N 43/22; A01P 3/00

(57) ABSTRACT

This disclosure includes a method of protecting crops from Cercospora leaf spot, by the foliar application of brassinosteroids. The method is able to be based on natural and synthesized material, 24-epibrassinolide and other commercial brassinolides, in contrast to those conventional fungicides cause pathogen resistances and the harm to human and the environment. This disclosure provides alternative and safe option against Cercospora leaf spot diseases.

### CROSS-REFERENCE TO RELATED APPLICATION(S)

This application claims priority under 35 U.S.C. § 119(e) of the U.S. Provisional Patent Application Ser. No. 63/193,954, filed May 27, 2021 and titled, “A Method For Protecting Plants Against Cercospora Leaf Spot,” which is also hereby incorporated by reference in its entirety for all purposes.

### FIELD OF THE INVENTION

The present invention relates to a method of and composition for protecting plants against diseases. More specifically, the present invention relates to protecting crops from Cercospora Leaf Spot.

### BACKGROUND OF THE INVENTION

Cercospora is a genus of ascomycete fungi. Normally, crops infected by Cercospora fungi often show leaf spots. When the disease is severe, it will lead to the withering or death of the leaves, and result in the loss of crop yields. The Cercospora leaf spot of beets, the early leaf spot of peanuts, the late leaf spot of peanuts, the frogeye leaf spot of soybean and the gray leaf spot of corn are common and deeply concerned.

Fungicides like Chlorothalonil, Tebuconazole, Azoxystribin, Pyraclostrobin, Difenoconazole, Mancozeb etc. are widely used for controlling Cercospora leaf spot diseases. However, the problem of pathogen resistance to these conventional fungicides and the concerns about the side effects on the environment urge the industry to find more effective and environmentally friendly solutions.

### SUMMARY OF THE INVENTION

Disclosed herein is a method of and composition for protecting plants against Cercospora leaf spot diseases based on brassinosteroids, which is safe to all mammals, bees, crops and environment. Brassinosteroids (BRs) are naturally occurring substance and present in higher plants and lower plants. BRs are present in all plant organs, such as pollen, anthers, seeds, leaves, stems, roots, flowers, grains and fruits with the highest concentrations found in pollen, seeds and fruits and considered as an obligatory plant constituent. BRs work as an elicitor of plant's self defense mechanisms against fungal diseases.

The present disclosure relates to methods of and compositions for treating crops, which suffer from Cercospora leaf spot diseases, such as, but not limited to the Cercospora leaf spot of beets, the early leaf spot of peanuts, the late leaf spot of peanuts, the frogeye leaf spot of soybean and the gray leaf spot of corn.

In an aspect, a method of protecting a plant from Cercospora leaf spots comprises preparing an application solution containing one or more compounds of a brassinosteroids and applying the solution on a plant leaves causing the one or more compounds to eliminate or inhibit a pathogen. In some embodiments, the one or more compounds comprise 24-epibrassinolide. In some other embodiments, a concentration of the one or more compounds in the application solution is 0.001-10 ppm. In some embodiments, a concentration of the one or more compounds in the application solution is 0.025-0.1 ppm. In other embodiments, the plant comprises sugar beet, fodder beet, beetroot, spinach, corn, peanut and soybean. In some other embodiments, the applying the solution on the plant comprises multiple foliar applications during the leaf development stage and after. In some embodiments, the applying the solution on the plant comprises one application at 2-4 leaves and another application at 5-8 leaves during the leaf development stage. In other embodiments, the method further comprises applying the solution in a 10-14 day intervals after first two applications.

In another aspect, an application solution for treating or preventing Cercospora leaf spots comprises one or more active compounds of brassinosteroids having a concentration capable of treating or reducing Cercospora leaf spots when applied to leaves of a plant and water. In some embodiments, the concentration is in a range between 0.05-0.1 ppm. In other embodiments, the concentration is in a range between 0.01-10 ppm. In some other embodiments, the one or more active compounds comprises 24-epibrassinolide. In some embodiments, the one or more active compounds comprise a main carbon skeleton having a norbrassinolide-type side chain. In some embodiments, the one or more active compounds comprise a main carbon skeleton having a brassinolide-type side chain. In other embodiments, the one or more active compounds comprise a main carbon skeleton having a 24-epibrassinolide-type side chain. In some other embodiments, the one or more active compounds comprise a main carbon skeleton having a dolicholide-type side chain. In some embodiments, the one or more active compounds comprise a main carbon skeleton having a 28-homobrassinolide-type side chain. In other embodiments, the one or more active compounds comprise a main carbon skeleton having a 25-homebrassinolide-type side chain. In some other embodiments, the one or more active compounds comprise a main carbon skeleton having a 28-homodolicholide-type side chain. In some embodiments, the one or more active compounds comprise a main carbon skeleton having a 25-homodolicholide-type side chain. In some other embodiments, the one or more active compounds comprise Cathasterone, 28-Epihomobrassinolide, 22,23,24-Triepibrassinolide, 14-hydroxylated brassinosteroid, 22,23-Epoxybrassinosteroid-2,3-diacetates, or Biobras-16.

In another aspect, a method of protecting a plant comprising applying a water solution containing an active compound from brassinosteroids in a predetermined effective concentration in inhibiting a fungal pathogen on leaves of a plant by inducing a plant's self-defense mechanism and re-applying the water solution after a predetermined period on the leaves of the plant. In some embodiments, the predetermined effective concentration is in a range of 0.02 ppm and 1 ppm. In other embodiments, the active compound comprises 24-epibrassinolide.

### BRIEF DESCRIPTION OF THE DRAWINGS

Embodiments will now be described by way of examples, with reference to the accompanying drawings which are meant to be exemplary and not limiting. For all figures mentioned herein, like numbered elements refer to like elements throughout.

FIG. 1 illustrates a method of protecting plants against Cercospora leaf spot according to some embodiments.

FIG. 2 illustrates another method of protecting plants against Cercospora leaf spot process according to some embodiments.

### DETAILED DESCRIPTION OF THE PREFERRED EMBODIMENT

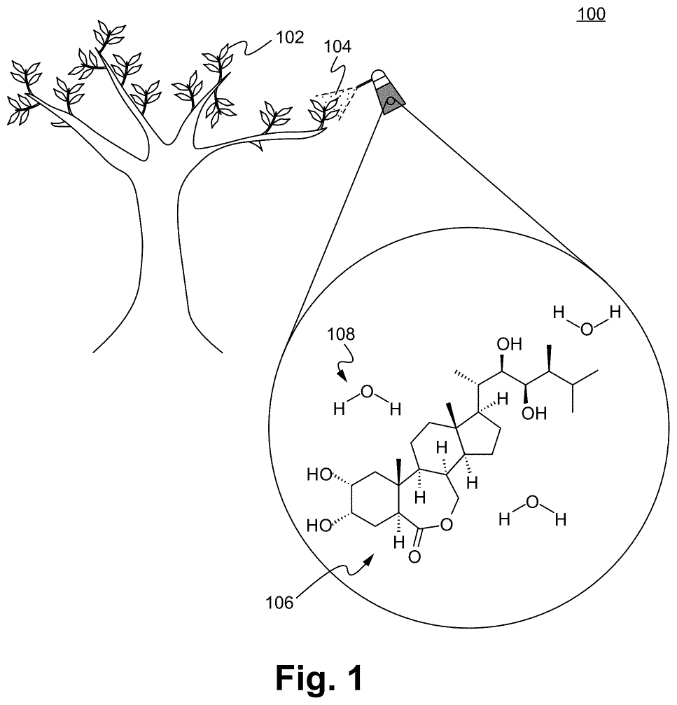

FIG. 1 illustrates a plant protecting method 100 against Cercospora leaf spot according to some embodiments. In some embodiments, a water solution 104 is applied on leaves 102 of a plant during the leaf development stage. In some embodiments, the water solution 104 comprises water 108 and an active compound from brassinosteroids 106. In some embodiments, the active compound comprises 24-epibrassinolide. The application dosages and procedures are further described in the following disclosure.

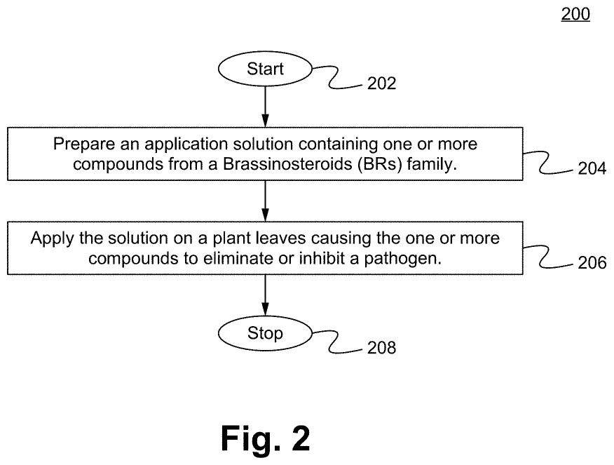

FIG. 2 illustrates another process 200 of protecting plants against Cercospora leaf spot according to some embodiments. The process 200 can start at a Step 202. At a Step 204, an application solution containing one or more compounds from a Brassinosteroids (BRs) family is prepared. At a step 206, the solution is applied on a plant's leaves causing the one or more compounds to eliminate or inhibit a pathogen. The process 200 is able to stop at a Step 208.

In one aspect, the compositions comprise one or more compositions of brassinosteroids (e.g., BRs family), (referred to as Component 1), which are able to be selected from one or more of the following groups Group B1 to Group B9:

Group B1: the main carbon skeleton of structures has norbrassinolide-type side chain, including:

28-Norbrassinolide, 28-Norcastasterone, 6-Deoxo-28-norcastasterone, 28-Nortyphasterol, 6-Deoxo-28-nortyphasterol, 28-Norteasterone, 6-Deoxo-28-norteasterone, 3-Dehydro-6-deoxo-28-norteasterone, and 26-Norcastasterone.

Group B2: the main carbon skeleton of structures has brassinolide-type side chain, including:

Brassinolide, Castasterone, 6-Deoxocastasterone, Typhasterol, Teasterone, 2-Epicastasterone, 3-Epicastasterone, 2,3-Diepicastasterone, 1β-Hydroxycastasterone, 1α-Hydroxy-3-epicastasterone, 3-Epi-6-deoxocastasterone, Teasterone-3-myristate, 3-Dehydroteasterone, Secasterone, 6-Deoxotyphasterol, 3-Dehydro-6-deoxoteasterone, 2-Deoxybrassinolide, Teasterone-3-laurate, 6-Deoxoteasterone, 6α-Hydroxycastasterone, 3-O-β-D-Glucopyranosylteasterone, 3-Epibrassinolide, 2,3-Diepisecasterone, Secasterol, Cryptolide, 23-Dehydro-2-epicastasterone, 3-Epi-2-deoxybrassinolide, and Castasterone 23-phosphate.

Group B3: the main carbon skeleton of structures has 24-epibrassinolide-type side chain, including:

24-Epicastasterone, 3, 24-Diepicastasterone, 24-Epibrassinolide, 6-Deoxo-24-epicastasterone, and 24-Episecasterone.

Group B4: the main carbon skeleton of structures has dolicholide-type side chain, including:

Dolicholide, Dolichosterone, and 6-Deoxodolichosterone.

Group B5: the main carbon skeleton of structures has 28-homobrassinolide-type side chain, including:

28-Homocastasterone, 28-Homobrassinolide, 28-Homoteasterone, 28-Homotyphasterol, and 6-Deoxe-28-homotyphasterol.

Group B6: the main carbon skeleton of structure has 25-homebrassinolide-type side chain, including:

25-Methylcastasterone.

Group B7: the main carbon skeleton of structure has 28-homodolicholide-type side chain, including:

28-Homodolicholide, 28-Homodolichosterone, and 6-Deoxo-28-homodolichosterone.

Group B8: the main carbon skeleton of structure has 25-homodolicholide-type side chain, including:

25-Methyldolichosterone, 2-Deoxy-25-methyldolichosterone, 3-Epi-2-deoxy-25-methyldolichosterone, 2-Epi-25-methyldolichosterone, 2,3-Diepi-25-methyldolichosterone, 6-Deoxo-25-methyldolichosterone, 23-O-β-D-Glucopyranosyl-25-methyldolichosterone, and 23-O-β-D-Glucopyranosyl-2-epi-25-methyldolichosterone.

Group B9: miscellaneous, including:

Cathasterone, 28-Epihomobrassinolide, 22,23,24-Triepibrassinolide, 14-hydroxylated brassinosteroid, 22,23-Epoxybrassinosteroid-2,3-diacetates, and Biobras-16.

In some embodiments, the Component 1 is 24-Epibrassinolide (EBR).

In some embodiments, the concentration of Component 1 in the application solution is in the range of from 0.001-10 ppm. In some embodiments, the concentration of Component 1 in the application solution is in the range of from 0.025-0.1 ppm.

In some embodiments, surfactants such as spreaders and penetration enhancers are added to the application solution to improve the efficacy. In some embodiments, surfactants used are naturally extracted chemicals, such as citrus oil and soaps or all natural extracted surfactants and penetrators. In some embodiments, surfactants used are synthesized chemicals, such as alkylphenol-alkylene oxide addition products, alcohol-alkylene oxide addition products, and organosilicone surfactants.

The application solution is able to be prepared by diluting the product that contains Component 1 with water. For example, the application solution is prepared by weighing 1 part of 24-Epibrassinolide at 0.01% SL (Soluble Concentrate) and 2000 parts of water and mixing well, which produces an application solution with a concentration of 0.05 ppm. The spreader and penetration enhancer are added according to corresponding labels.

Crops/plants that can use this application solution include but are not limited to sugar beet, fodder beet, beetroot, spinach, corn, peanut and soybean.

The selected exemplary application method is multiple foliar applications during the leaf development stage and after. The application includes at least two applications during the leaf development stage, for example one application at 2-4 leaves and another application at 5-8 leaves. More applications may be needed at 10-14 day intervals after first two applications.

In some embodiments, some or all of the active compounds in the above Group B1 to Group B9 of BRs family are tested to have similar efficacy like 24-Epibrassinolide.

### EXAMPLES

### Example 1

A field study is conducted in Alpera/Albacete, Spain to determine the efficacy and selectivity of an embodiment (e.g., Sunergist), one formulated product containing 24-Epibrassinolide, which is compared with the application of using SCORE 25 EC (Difenoconazole 250 g/L) on sugar beets (Detroit variety).

The trial is performed under open field conditions and comprised of 4 treated plots and 1 untreated control plot with individual plot size of 10 m² (100 plants). The untreated plot was used as a control to compare their results with the treated plots and for checking the normal growth and development of the crop under those conditions. Three applications were carried out, the application A at BBCH 14 (4 leaves unfolded), the application B at BBCH 18 (8 leaves unfolded), and finally, the application C was done at BBCH 34 (40% ground cover).

TABLE 1
Information on test(s) and reference item(s)

| Product and formulation | Active ingredient and content |
|---|---|
| The embodiment (e.g., | 24-Epibrassinolide solution 0.01% |
| Sunergist SL) | |
| Nufilm - 17 | Dimentene 96% |
| Score 25 EC | Difenoconazole 250 g/l |

TABLE 2
Application schedule and product description

| T | Products and Formulation | Dosage Rate | Application Timing | | |
|---|---|---|---|---|---|
| T1 | Untreated | | | | |
| T2 | Sunergist (0.01% 24- | 0.5 mL/L | A | B | C |
| | Epibrassinolide) | 300 mL/ha | | | |
| | Nufilm-17 | | | | |
| T3 | Sunergist (0.01% 24- | 0.5 mL/L | A | B | C |
| | Epibrassinolide) | 300 mL/ha | | | |
| | Nufilm-17 | | | | |
| T4 | Sunergist (0.01% 24- | 0.5 mL/L | A | B | |
| | Epibrassinolide) | 300 mL/ha | | | |
| | Nufilm-17 | | | | |
| T5 | Score 25 EC | 300 mL/ha | A | B | C |

Comments

| Application Timing | | Spray Volume |
|---|---|---|
| A | BBCH 14 (4 leaves unfolded) | 500 L/ha |
| B | BBCH 18 (8 leaves unfolded) | 500 L/ha |
| C | BBCH 34 (40% ground cover) | 500 L/ha |

TABLE 3
Number of Infected Plants Per Plot (Pest incidence) and Efficacy

| Pest Scientific Name | | Cercospora beticola | Cercospora beticola |
|---|---|---|---|
| Pest Name | | Leaf spot of beets | Leaf spot of beets |
| Rating Data Type | | COUINF | PESINC |
| Rating Unit | | Number | % UNCK |
| Crop Stage | | BBCH 49 | BBCH 49 |
| Tr. No | Tr. Name | | |
| T1 | UTC | 26.25a | 0 |
| T2 | Sunergist & | 12.00b | 65a |
| | Nufilm - 17 | | |
| T3 | Sunergist & | 15.00b | 44b |
| | Nufilm - 17 | | |
| T4 | Sunergist & | 14.75b | 54ab |
| | Nufilm - 17 | | |
| T5 | Score 25 EC | 14.00b | 55ab |

| | | |
|---|---|---|
| LSD P = 0.05 | 2.865 | 9.8 |
| CV | 11.34 | 14.58 |
| Bartlett's X2 | 0.93 | 0.616 |
| P(Bartlett's X2) | 0.92 | 0.893 |
| Skewness | 1.3045 | −1.1211 |
| Kurtosis | 0.6665 | −0.0722 |
| Replicate F | 1.735 | 0.456 |
| Replicate Prob(F) | 0.2130 | 0.7180 |
| Treatment F | 36.672 | 64.461 |
| Treatment Prob(F) | 0.0001 | 0.0001 |

TABLE 4
Percentage of plants area affected by
Cercospora beticola PESSEV and efficacy

| Pest Scientific Name | | Cercospora beticola | Cercospora beticola |
|---|---|---|---|
| Pest Name | | Leaf spot of beets | Leaf spot of beets |
| Rating Data Type | | PESSEV | PESSEV |
| Rating Unit | | % | % UNCK |
| Crop Stage | | BBCH 49 | BBCH 49 |
| Tr. No | Tr. Name | | |
| T1 | UTC | 42.38a | 0 |
| T2 | Sunergist & | 3.75c | 91a |
| | Nufilm - 17 | | |
| T3 | Sunergist & | 9.13b | 78b |
| | Nufilm - 17 | | |
| T4 | Sunergist & | 5.75bc | 86a |
| | Nufilm - 17 | | |
| T5 | Score 25 EC | 6.31bc | 85a |

| | | |
|---|---|---|
| LSD P = 0.05 | 3.765 | 5.5 |
| CV | 18.15 | 5.24 |
| Bartlett's X2 | 6.83 | 0.258 |
| P(Bartlett's X2) | 0.145 | 0.968 |
| Skewness | 1.6005 | −1.5363 |
| Kurtosis | 0.8879 | 0.5538 |
| Replicate F | 0.447 | 1.059 |
| Replicate Prob(F) | 0.7239 | 0.4028 |
| Treatment F | 177.446 | 461.985 |
| Treatment Prob(F) | 0.0001 | 0.0001 |

TABLE 5
Yield of sugar beet roots in kg/plot

| Pest Scientific Name | | Cercospora beticola |
|---|---|---|
| Pest Name | | Leaf spot of beets |
| Rating Data Type | | Yield |
| Rating Unit | | kg/plot |
| Crop Stage | | BBCH 49 |
| Tr. No | Tr. Name | |
| T1 | UTC | 88.79a (100.0%) |
| T2 | Sunergist & | 91.28a (102.8%) |
| | Nufilm - 17 | |
| T3 | Sunergist & | 91.53a (103.1%) |
| | Nufilm - 17 | |
| T4 | Sunergist & | 92.62a (104.3%) |
| | Nufilm - 17 | |
| T5 | Score 25 EC | 91.51a (103.1%) |

| | |
|---|---|
| LSD P = 0.05 | 21.562 |
| CV | 15.35 |
| Bartlett's X2 | 3.29 |
| P(Bartlett's X2) | 0.511 |
| Skewness | −0.5791 |
| Kurtosis | −0.0553 |
| Replicate F | 0.503 |
| Replicate Prob(F) | 0.6873 |
| Treatment F | 0.041 |
| Treatment Prob(F) | 0.9964 |

Based on the data in the Tables 3-5, the result shows that:
(1) The application of Sunergist (24-epibrassinolide 0.01 SL; an embodiment of the present disclosure) at the rate of 0.5 mL/L (0.05 ppm) significantly decreased the percentage of infected leaves and the infection of leaves compared to the untreated plots.
(2) Compared to the commercial standard treated with Score 25 EC (Difenoconazole), Sunergist (24-epibrassinolide 0.01% SL) showed similar or better efficacy against Cercospora leaf spot on sugar beets.

### Example 2

One field study is conducted in Ptolemaida/Kozani, Greece to evaluate the efficacy of Sunergist (24-epibrassinolide 0.01% SL) against Cercospora beticola on sugar beet as solo application and in combination with the national standard. The sugar beet variety is Beta vulgaris vulg. altissima.

In total, 5 treatments were applied. More specifically, 2 treatments of the test product Sunergist SL in addition with Silwet Gold, 1 treatment of the test product Sunergist SL in addition with Silwet Gold and reference product Score 25 EC, 1 treatment of the reference product Score 25 EC and 1 untreated control, were arranged in the complete randomized blocks design.

TABLE 6
Information on test(s) and reference item(s)

| Product and formulation | Active ingredient and content |
|---|---|
| Sunergist SL | 24-Epibrassinolide solution 0.01% |
| SILWET GOLD | Heptamethyl trisiloxane 83% w/v |
| Score 25 EC | Difenoconazole 25% w/v |

TABLE 7
Application schedule and product description

| T | Products and Formulation | Dosage Rate | Application Timing |
|---|---|---|---|
| T1 | Untreated | | |
| T2 | Sunergist (0.01% 24- | 1 mL/L | ABC |
| | Epibrassinolide) | 10 mL/ha | |
| | Silwet Gold | | |
| T3 | Sunergist (0.01% 24- | 0.5 mL/L | ABC |
| | Epibrassinolide) | 10 mL/ha | |
| | Silwet Gold | | |
| T4 | Sunergist (0.01% 24- | 0.5 mL/L | ABC |
| | Epibrassinolide) | 10 mL/ha | ABC |
| | Silwet Gold Score | 400 mL/ha | CD |
| T5 | Score 25 EC | 300 mL/ha | CD |

Comments

| Application Timing | | Spray Water Volume |
|---|---|---|
| A | BBCH 12-14 (2-4 leaves unfolded) | Sunergist: 200 L/ha; |
| | | Score: 300 L/ha |
| B | BBCH 15-18 (5-8 leaves unfolded) | Sunergist: 200 L/ha; |
| | | Score: 500 L/ha |
| C | BBCH 31-34 (10%-40% ground cover) | 300 L/ha |
| D | BBCH 39 (90% ground cover) | 500 L/ha |

TABLE 8
Percentage of Infected Plants (incidence)
on 20 plants per plot and Efficacy

| Pest Scientific Name | | Cercospora beticola | Cercospora beticola |
|---|---|---|---|
| Pest Name | | Leaf spot of beets | Leaf spot of beets |
| Rating Data Type | | COUINF | PESINC |
| Rating Unit | | % | % UNCK |
| Rating time | | Harvest | Harvest |
| T | Tr. Name | | |
| T1 | UTC | 66.25a | 0 |
| T2 | Sunergist (0.01% 24- | 40.00bc | 39.76 |
| | Epibrassinolide) | | |
| | Silwet Gold | | |
| T3 | Sunergist (0.01% 24- | 47.50b | 27.80 |
| | Epibrassinolide) | | |
| | Silwet Gold | | |
| T4 | Sunergist (0.01% 24- | 27.50c | 57.32 |
| | Epibrassinolide) | | |
| | Silwet Gold Score | | |
| T5 | Score 25 EC | 30.00bc | 53.99 |

TABLE 9
Percentage of plants area affected (SEVERITY)
on 20 plants per plot and efficacy

| Pest Scientific Name | | Cercospora beticola | Cercospora beticola |
|---|---|---|---|
| Pest Name | | Leaf spot of beets | Leaf spot of beets |
| Rating Data Type | | PESSEV | PESSEV |
| Rating Unit | | % | % UNCK |
| Rating time | | Harvest | Harvest |
| T | Tr. Name | | |
| T1 | UTC | 23.25a | 0 |
| T2 | Sunergist (0.01% 24- | 2.81bc | 87.95 |
| | Epibrassinolide) | | |
| | Silwet Gold | | |
| T3 | Sunergist (0.01% 24- | 3.50b | 84.98 |
| | Epibrassinolide) | | |
| | Silwet Gold | | |
| T4 | Sunergist (0.01% 24- | 2.13cd | 90.73 |
| | Epibrassinolide) | | |
| | Silwet Gold Score | | |
| T5 | Score 25 EC | 1.20d | 94.82 |

TABLE 10
Yield of sugar beet roots in kg/plot

| Pest Scientific Name | | Cercospora beticola |
|---|---|---|
| Pest Name | | Leaf spot of beets |
| Rating Data Type | | Yield |
| Rating Unit | | kg/plot |
| Rate time | | Harvest |
| Tr. No | Tr. Name | |
| T1 | UTC | 119.25 b |
| T2 | Sunergist (0.01% 24- | 143.23 a |
| | Epibrassinolide) | |
| | Silwet Gold | |
| T3 | Sunergist (0.01% 24- | 149.73 a |
| | Epibrassinolide) | |
| | Silwet Gold | |
| T4 | Sunergist (0.01% 24- | 141.40 a |
| | Epibrassinolide) | |
| | Silwet Gold Score | |
| T5 | Score 25 EC | 141.41 a |

Based on the data in the Tables 6-10, the result shows that:
(1) The application of Sunergist (24-epibrassinolide 0.01 SL) at the rate of 0.5 mL/L (0.05ppm) and 1 mL/L (0.1 ppm) significantly decreased the percentage of infected leaves and the infection of leaves compared to the untreated plots.
(2) Compared to the commercial standard treated with Score 25 EC (Difenoconazole), Sunergist (24-epibrassinolide 0.01% SL) showed similar efficacy against Cercospora leaf spot on sugar beets and received higher yields.

In utilization, the composition is used to treat and protect a plant from Cercospora leaf spots.

In operation, a method of protecting a plant from Cercospora leaf spots comprises preparing an application solution containing one or more compounds of brassinosteroids and apply the solution on a plant's leaves causing the one or more compounds to eliminate or inhibit a pathogen.

The present invention has been described in terms of specific embodiments incorporating details to facilitate the understanding of principles of construction and operation of the invention. Such reference herein to specific embodiments and details thereof is not intended to limit the scope of the claims appended hereto. It is readily apparent to one skilled in the art that other various modifications can be made in the embodiment chosen for illustration without departing from the spirit and scope of the invention as defined by the claims. Features in various examples or embodiments are applicable throughout the Present Specification.

We claim:

1. A method of protecting a plant from Cercospora leaf spots comprising:
a) preparing an application solution containing one or more compounds of brassinosteroids; and
b) applying the solution on a plant's leaves causing the one or more compounds to eliminate or inhibit a pathogen.

2. The method of claim 1, wherein the one or more compounds comprise 24-Epibrassinolide.

3. The method of claim 1, wherein a concentration of the one or more compounds in the application solution is 0.001-10 ppm.

4. The method of claim 1, wherein a concentration of the one or more compounds in the application solution is 0.025-0.1 ppm.

5. The method of claim 1, wherein the plant comprises sugar beet, fodder beet, beetroot, spinach, corn, peanut and soybean.

6. The method of claim 1, wherein the applying the solution on the plant's leaves comprises multiple foliar applications during the leaf development stage and after.

7. The method of claim 1, wherein the applying the solution on the plant's leaves comprises one application at 2-4 leaves and another application at 5-8 leaves during the leaf development stage.

8. The method of claim 7, further comprising applying the solution in 10-14 days intervals after first two applications.

9. An application solution for treating or preventing Cercospora leaf spots comprises:
a) one or more active compounds of brassinosteroids having a concentration capable of treating or reducing Cercospora leaf spots when applied on leaves of a plant; and
b) water.

10. The application solution of claim 9, wherein the concentration is in a range between 0.001-10 ppm.

11. The application solution of claim 9, wherein the concentration is in a range between 0.025-0.1 ppm.

12. The application solution of claim 9, wherein the one or more active compounds comprises 24-epibrassinolide.

13. The application solution of claim 9, wherein the one or more active compounds comprise a main carbon skeleton having a norbrassinolide-type side chain.

14. The application solution of claim 9, wherein the one or more active compounds comprise a main carbon skeleton having a brassinolide-type side chain.

15. The application solution of claim 9, wherein the one or more active compounds comprise a main carbon skeleton having a 24-epibrassinolide-type side chain.

16. The application solution of claim 9, wherein the one or more active compounds comprise a main carbon skeleton having a dolicholide-type side chain.

17. The application solution of claim 9, wherein the one or more active compounds comprise a main carbon skeleton having a 28-homobrassinolide-type side chain.

18. The application solution of claim 9, wherein the one or more active compounds comprise a main carbon skeleton having a 25-homebrassinolide-type side chain.

19. The application solution of claim 9, wherein the one or more active compounds comprise a main carbon skeleton having a 28-homodolicholide-type side chain.

20. The application solution of claim 9, wherein the one or more active compounds comprise a main carbon skeleton having a 25-homodolicholide-type side chain.

21. The application solution of claim 9, wherein the one or more active compounds comprise Cathasterone, 28-Epihomobrassinolide, 22,23,24-Triepibrassinolide, 14-hydroxylated brassinosteroid, 22,23-Epoxybrassinosteroid-2,3-diacetates, or Biobras-16.

22. A method of protecting a plant comprising:
a) applying a water solution containing an active compound from brassinosteroids in a predetermined effective concentration in inhibiting a fungal pathogen on leaves of a plant; and
b) re-applying the water solution after a predetermined period on the leaves of the plant.

23. The method of claim 22, wherein the predetermined effective concentration is in a range of 0.001 ppm and 10 ppm.

24. The method of claim 22, wherein the active compound comprises 24-Epibrassinolide.

25. The method of claim 22, wherein the predetermined period comprises after 5-8 leaves are shown.
